(19) United States
(12) Patent Application Publication
(10) Pub. No.: US 2009/0256719 A1
(43) Pub. Date: Oct. 15, 2009

(54) Utility monitoring system

(76) Inventors: Dave Boissonneault, Victoriaville (CA); Gilles Cusson, Calgary (CA)

Correspondence Address: Franz BONSANG;c/o EQUINOX PROTECTION, 410 - 1500, Du College, St-Laurent, QC, H4L 5G6, CA

(21) Appl. No.: 12/081,254

(22) Filed: Apr. 14, 2008

(51) Int. Cl. G08B 23/00

(52) U.S. Cl. 340/870.02

(57) ABSTRACT

A system for monitoring consumption of a utility by a building unit is provided. The system includes a sensor disposed externally yet proximal to a meter for recording consumption of the utility and having an indicator which indicates an event whenever a predefined quantity of the utility is consumed by the building unit. The sensor is configured for detecting each event and is connected to a controller having a controller, the controller being situated within the building unit. The controller is programmable with the predetermined event quantity as well as tariff information for the event and counts each event detected by the sensor. Based on the events counted, the tariff information, and the predefined event quantity, the controller generates consumption information, including approximate consumption totals of the utility consumed and costs therefor. The consumption information is selectively displayed on a display unit connected to the controller.

### FIELD OF THE INVENTION

The present invention relates to utility monitoring systems, and methods and is more particularly concerned with a utility monitoring system disposed externally to a utility meter for a building unit for monitoring consumption of a utility by the building unit.

### BACKGROUND OF THE INVENTION

Utility monitoring systems for monitoring utility usage are well known in the art. For example, U.S. Pat. No. 4,120,031, issued to Kincheloe et al. on Oct. 10, 1978 teaches a utility monitoring system connectable to a utility meter connected to the utility system of the building unit for example a house, apartment, office, or the like, for billing purposes. The utility meter is installed by utility providers who periodically read the utility meter to determine the amount of the utility consumed by the utility system for the building unit. The utility monitoring system has an interface module installed within the building unit and which is connected to the meter and receives pulses in response to consumption of the utility which are used to calculate consumption information, such as an amount of the utility consumed or a cost thereof. Thus, the monitor system allows the user to view the consumption information, such as an amount of the utility consumed or a cost thereof, from the interface module within the building unit. The utility meter is typically installed outside of the building unit, for example on an exterior of the building or in a utility room in the building dedicated for placement of the utility meter, and connected to the utility system for the building unit, thus allowing the utility provider to read the meter without having to enter the building unit. Accordingly, the utility monitoring system allows a user of the building unit to easily access the consumption information within the building unit without having to consult the meter, which is often difficult, if not impossible for the user as the utility meter when the utility meter is disposed outside of the building unit.

Similarly, U.S. Pat. No. 7,043,380, issued to Rodenberg, Ill. et al. on May 9, 2006, discloses a monitoring system which has an interface module connected directly to the meter or directly to the utility system, notably an electrical system, and which receives signals therefrom which indicate consumption. The monitor system converts the signals into consumption information conveniently viewable inside the building unit from the interface unit.

Unfortunately, typical monitoring systems, including those described above, are often difficult to install in that interface module must often be directly connected to the utility system or within the utility meter, for example by installation of a sensor within the system or meter and which is connected to the interface module within the building unit. Such installation requirements are inconvenient and may render such monitoring systems unappealing to many users. Further, installation of such systems may require advanced technical knowledge and specialized personnel, which may further discourage eventual users from purchasing the system. Additionally, utility providers may not approve of modifications to the utility systems or meters. Additionally, improper installation of such systems, especially where the utility system or meters are modified, could pose dangers, for example fire hazards for electrical systems, to the safety of the building unit or the users thereof.

Accordingly, there is a need for an improved utility monitoring system that is easily installed.

### SUMMARY OF THE INVENTION

It is therefore a general object of the present invention to provide an improved utility monitoring system that is easily installed.

An advantage of the present invention is that the utility monitoring system provided thereby can be installed externally to the utility meter.

Another advantage of the present invention is that the utility monitoring system provided thereby does not require internal or external modification of the utility meter or the utility system.

A further advantage of the present invention is that the utility monitoring system provided thereby can be installed using simple tools.

Still another advantage of the present invention is that the utility monitoring system is easily configured.

In a first aspect, there is provided a monitor system for monitoring utility consumption of a public utility by a utility system of a building unit, the utility system connecting the building unit to the public utility, the utility system being connected to a utility monitor having an indicator providing a predefined event whenever a respective predefined event quantity is consumed by the building unit, the monitor system comprising:
a sensor disposed external the meter and proximal thereto, the sensor being configured for detecting the event;
a controller situated within the building unit and programmable with the predefined event unit and connected to the sensor, the controller being configured for calculating at least one event total calculated by counting each event detected by the sensor;
a display connected to the controller for displaying consumption information generated by the controller based on the event total and the predefined event unit.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a schematic view of an embodiment of a monitoring system for a utility in accordance with an embodiment of the present invention;

FIG. 2 is a schematic view of a variant of the monitoring system of FIG. 1, showing an alternative attachment for connecting the system to the meter; and

FIG. 3 is a schematic view of a monitoring system for a utility in accordance with another embodiment.

### DETAILED DESCRIPTION OF THE PREFERRED EMBODIMENTS

With reference to the annexed drawings the preferred embodiments of the present invention will be herein described for indicative purpose and by no means as of limitation.

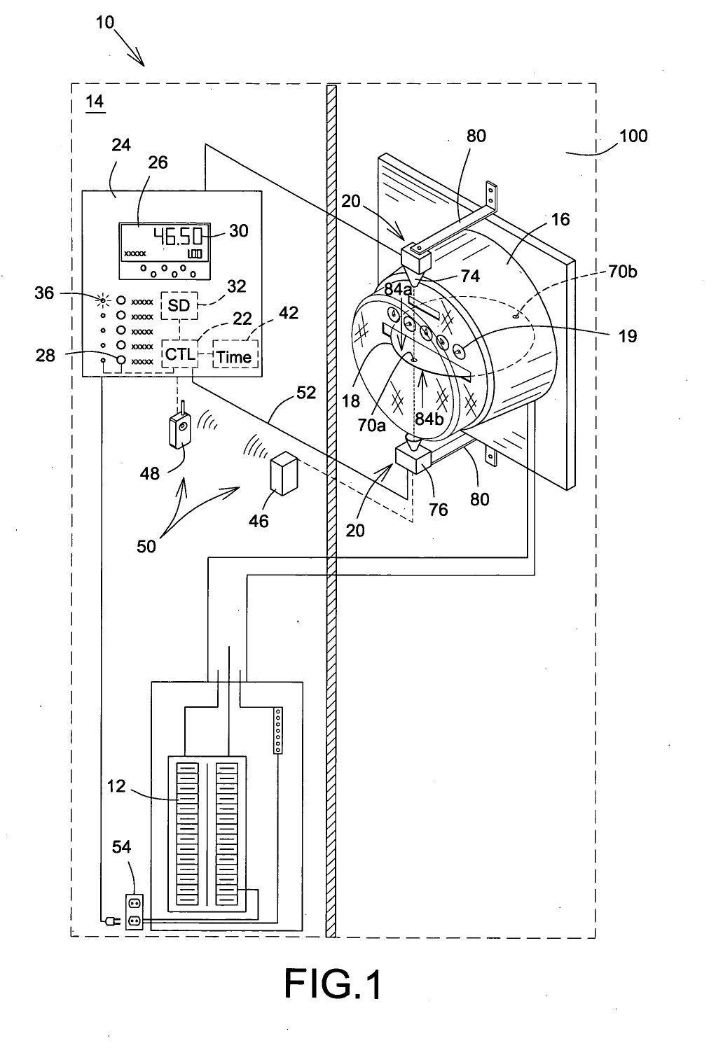

In order to explain the invention in general terms, reference is now made to FIG. 1, there is shown an embodiment of a monitor system, shown generally as 10, for monitoring consumption, i.e. usage, of a utility by a utility system 12 of a building unit 14, the utility system 12 providing the connection by which the utility provider, not shown, provides the utility to the building unit 14. The utility system 12 is connected to a utility meter 16, often situated outside of the building unit 14 as shown. The utility meter 16 is periodically read by the utility provider after a predefined period of time, for example at the end of a billing period of time, for the purposes of determining consumption information 30 relative to the consumption of the utility by the building unit 14. For example, the consumption information 30 could include an amount of the utility consumed or a consumption cost for the amount of the utility consumed. The building unit may be a house, an apartment in a building, an office in a building, or any other building structure, either stand-alone or incorporated into another structure, having a utility system 12 that connects building unit 14 to the public utility and which has a meter 16 for recording consumption of the utility by the building unit 14.

The meter 16 has an indicator 18 which indicates generally indicates that consumption of the utility is occurring, and which provides a predefined event when a predefined event quantity of the utility is consumed by the utility system 12 of the building unit 14. Preferably, the meter 16 also has one or more readable consumption indication devices or means 19, such as dials, displays, or the like, possibly connected to the indicator 18, which show the amount of the utility consumed and which are typically read by the utility provider.

Referring still to the system 10 for generic purposes, the system 10 consists of a sensor arrangement, shown generally as 20, which is situated outside of the meter 16, preferably proximal thereto, and which is configured for detecting every occurrence of the event. The sensor 20 is, in turn, connected to a programmable controller 22, for example a computing device or microprocessor 22, preferably disposed in an interface module 24 situated in a location, preferably within the building unit 14 itself, easily accessible to a user of the building unit 14. The controller 22 is connected to at least one user input device 28 for entering user inputs to the controller 22 and to a display unit 26 which displays consumption information 30 generated by the controller 22, as well as user inputs. A storage device 32, for example a disc drive, memory chip, or card, is also connected to the controller 22 and is used for storage by the controller 22 of, for example, user inputs from the input device 28 and consumption information 30 generated thereby.

While the utility meter 16 shown in FIG. 1 is an electricity meter 16 for an electrical utility provider providing electricity to the electrical system 12 of a building unit 14, it should be noted that the system 10 may be deployed with any utility for which a meter 16 having an indicator 18 which produced an event readable by the sensor 20 for a predefined event amount of the utility consumed. For example, the system, 10 may be deployed, for example, for example, for water utilities, oil utilities, gas utilities, or the like. Specific use of the system 10 with an electrical utility and electricity meter 16 will be described below.

Referring still to implementations of the system 10 applicable to any utility, the display unit 26 may be any kind of display, such as cathode ray tube, plasma, liquid crystal, or light emitting diode, capable of displaying alphanumeric characters. The input device 28 may be any device by which user inputs may be provided, for example such as push buttons, touch sensitive buttons or screens, keyboards, keypads, or the like. Optional signaling devices 36, for example lights or an audio device, connected to at least one of the controller 22 and the input device 28 and preferably disposed on the user interface module 24, may be included to indicate that a user input device 28 is being used or a malfunction in the system 10. The signaling devices 36 may also provide a signal or alarm, based on the consumption information 30, when consumption of the utility has reached a predefined rate or level. A timing device 42, connected to the controller 22 and the input device 28, is programmable from the input device 28 with time information, such as a time of day, day of week, date, and year and updates the time information as time progresses. The timing device 42, which may also be integrated with the controller 22, may be a clock, timer, or any other device which permits tracking or calculation of periods of time and time of day, date, and year.

Referring still to implementations of the system 10 applicable to any utility, the sensor 20 is connected, either by a wired connection 52, for example a sensor connection wire 52, or by a wireless connection, shown generally as 50, to the interface module 24, and more specifically to the controller 22. For a wireless connection 50 a wireless transceiver or transmitter 46 is connected to the sensor 20 and a wireless receiver or transceiver 48 is connected to the controller 22. The sensor 20, controller 22, interface module 24, display device 26, input device 28, and signaling devices 36 are connected, either directly or indirectly, to an electrical power source 12, 54, for example the electrical system 12 of the building unit 14 or an electrical outlet 54 of the electrical system 12, a battery, solar panel, electrical generator, or any other source of electrical power sufficient to provide electricity required thereby.

Referring still to implementations of the system 10 applicable to any utility, the controller 22 is programmable with the predefined event quantity for an event, which may be entered as a user input with the user input device 28 and stored on the storage device 32. For example, the user could enter the exact predefined event quantity from the user input device 28 for a single event. Alternatively, the predefined event quantity may be entered as an alternative amount of the utility consumed for an alternative number of occurrences of the events, also programmable using the user input device 28, which can be mathematically converted by the computing device, as is well known in the art, into the predefined event quantity per event, proportionally equal thereto, by dividing the alternative amount of the utility by the alternative number of occurrences of the event corresponding thereto. The data for determining the predefined event quantity is typically provided to the user by the utility provider and may be preprogrammed into the controller 22 thereby, if desired. The predefined event quantity is, preferably, expressed as a measure commonly used for consumption of the utility, for example kilowatt-hours for electricity, liters or gallons for water, gasoline, oil, or the like. However, any measure typically used for expressing consumption of a utility may be used.

Referring still to implementations of the system 10 applicable to any utility, the controller 22 is further programmable, using the input device 28, with at least one event tariff representing the cost of the utility for each event quantity consumed, and thereby each event. The event tariff may be entered directly as a monetary amount per event quantity, thereby corresponding to a monetary amount per event. Alternatively, the event tariff may be entered as another tariff corresponding to alternative consumption amount of the utility or number of occurrences of events, from which the event tariff, proportional thereto, from which the predefined event may be calculated by the controller 22 in similar fashion as for the predefined event quantity. For example, if the tariff entered is for an alternative number of events, the controller may convert the tariff entered to an event tariff by dividing the alternative number of events by the alterative number of events corresponding thereto. If the tariff entered is for an alternative consumption quantity, other than the predefined event quantity, then the alternative consumption quantity may be divided by the predefined event quantity to determine the number of events for the tariff entered. The tariff entered may then be divided by the number of events for the tariff entered to determine the event tariff.

For each event tariff, there may be a corresponding tariff event range and tariff range period to which the event tariff is applicable, again programmable using the input device 28. The tariff event range corresponds to the range of events, i.e. from a lower event limit to an upper event limit, between which, during the range time period, the event tariff will be used for calculating consumption costs for the utility consumed. In other words, if an event total of events counted during a tariff period is within the tariff event range for a given tariff, that tariff will be applied, for example added to a consumption cost for the range period, for every event in the period that walls within the tariff event range. Once again, the data for event ranges, often expressed by the utility provider as consumption ranges of the utility consumed for a given tariff period, and tariff periods is provided by the utility provider and is programmable by the utility provider or by a user into the controller 22 using the input device 28. For example, such tariffs and ranges are typically specified, for example, on utility bills issued by the utility provider. By associating using tariffs with event ranges and tariff periods, the controller 22 may, in calculating costs for the utility, take into account peak usage periods, often corresponding to elevated event tariffs, as well as graduated consumption tariffs, corresponding to the event tariffs which increase as usage increases during a predefined period of time which may include one or more range periods of time.

Preferably, all data entered, i.e. programmed, into the system 10 including tariffs, ranges, time information, consumption information 30, and predefined event quantities may be programmed using with user input device 28, preferably prior to use of the system 10 for monitoring consumption of the utility. Further, all such data and all consumption information 30 may be requested and viewed by using the input device 28 in conjunction with the display device 26.

Referring still to implementations of the system 10, in use, the controller 22 counts each occurrence of the event, which is preferably signaled to the controller 22 by a signal sent by the sensor 20 to the controller 22 over the connection 50, 52 every time the sensor 20 detects the event. By counting each occurrence of the event, the controller 22 maintains at least one running event count total, wherein each occurrence is added to the event count total. The event count total is typically set to zero (0) when use of the system 10 is initiated to monitor consumption of the utility and may be reset to 0, either automatically or using the input device 28.

Typically, the controller 22 will maintain one or more running event totals as one or more sample event totals for respective sample time periods of time and a cumulative count total which represents the total amount of events detected since all event totals were last set to zero. Thus a sample event total is the total number of events detected by the sensor during a sample time period, which typically repeats itself and for which the sample event count or total is reset to 0 at the beginning of each sample period. Thus, the sample event total represents a constant sampling of the rate of consumption for a sample time period of time and allows for updating, in real time, of an estimated or projected consumption rate based thereupon, expressed either as a cost, event total, or consumption total, on the display screen each time a sample consumption period ends. The sample time period is programmable using the input device 28. The cumulative count total is maintained over a, preferably longer, cumulative time period of time, for example a billing period such as a week, month, or year and is set or reset to 0 at the beginning of each cumulative period of time, which is also programmable from the user input device 28.

By adding the predefined unit quantity to a running predefined consumption total for each event in an event count total, i.e. for each event detected, a corresponding sample period consumption totals and cumulative period consumption totals for each sample event total and cumulative event total, representing the consumption of the utility for the sample and cumulative time periods corresponding thereto, are calculated by the controller 22. Alternatively, as is well known in the art, the sample event total or cumulative event total could simply be multiplied by predefined event unit. All sample and cumulative event totals may be, and preferably are, stored on the storage device 32. Further periodic and cumulative event totals and corresponding periodic and cumulative consumption amounts are consumption information 30 which may be displayed on the display unit 26 by using the user input device 28.

By using the sample event total and sample consumption totals, and if desired cumulative event totals and consumption totals, the consumption information 30 calculated by the controller 22 may also include projected event totals and projected consumption totals for projected, typically future, time periods of time, which are also programmable into the controller 22 using the input device 28. Typically, but not necessarily, the projected time period is greater than the sample time period. For example, if a sample time period is a second or minute, a projected period could be an hour, day, month or year. Once a sample event total or sample period consumption total has been determined by the controller 12, a projected event total or projected period consumption total may, respectively, be calculated by the controller 22 by multiplying the quotient obtained by dividing the projected period by the sample period by, respectively, the sample event total or the sample period consumption total. In other words, the projected period consumption total for a projected time period is proportionally equal to the sample period event total per sample time period or sample period consumption total per sample time period. As will be readily understood by one skilled in the art, since the relationship, i.e. the ratio, between events and consumption is programmed into the controller 22 or accessible thereby from the storage device 28, the controller 22 can also calculate projected consumption totals from event totals.

In addition, the consumption information 30 generated by the controller 22 may also include the sample period consumption costs for sample time periods, projected period consumption costs for projected time periods, and cumulative consumption costs for the cumulative time period, all of which are displayable on the display unit 26 upon request from the input device 28 and which may be stored on the storage device 32. The consumption costs are calculated by addition, for a respective cost total for the time period, of a predefined event tariff for every event counted or calculated for the sample time period, projected time period, or cumulative time period. The predefined event tariff corresponds to the cost per event and may vary, as described above, based on the event range therefor and range period. Specifically, when the sample, cumulative, or projected event count total or sample, cumulative, or projected consumption total is, respectively, within the predefined event range and the sample, cumulative, or projected time period coincides with the range period therefore, the controller adds the predefined event tariff for that event range to the cost total. When a predefined event tariff has been added for every event of the sample, projected, or cumulative event total, then the resulting cost total is the sample consumption cost, projected consumption cost, or cumulative consumption cost.

Additionally, the controller 22 is further programmable with consumption alarm thresholds applicable to current, projected, and cumulative period consumption totals. Should the consumption total for the time period rise above the threshold, then an alarm, either visual or auditory, using the signaling device 36 or display device 26, will be generated by the controller 22.

As noted above, the controller 22 is programmable to store the cumulative event count, cumulative consumption total, and the cumulative period consumption cost for a cumulative period corresponding to a billing period defined by the utility provider. A sample time period could also be defined for the billing period. Either way, the user can, using the input device 28, view the total cumulative cost for the usage of the utility on the display device 26 at any point during the billing period. Further, the event count, consumption total, and the consumption cost for the billing period can be reset to 0 at the beginning or end of any billing period, either manually by the user using the input device 28 or automatically by the controller 22, thus allowing actual consumption and cost of the utility to be tracked by the user throughout the billing period.

Optionally, the controller 22 could be connected to a payment clearance system by a network, not shown, and to which the utility provider is also connected, thus allowing a user to make payments for each billing period based on the approximate consumption cost for the billing period calculated by the controller 22. For example, the user could view the consumption cost for the billing period at the end of the billing period on the display unit 26 and enter, using the input device 28, payment information, such as the payment amount, bank account numbers, credit or debit card numbers, and passwords. The payment information would then be forwarded to the payment clearance system which, using the payment information, would forward payment to the utility provider.

Having generally described the system 10 and its use with a utility meter 16 for any utility, specific examples for use with electricity meters 16 will be described with reference to FIGS. 1, 2 and 3. As shown in the exemplary embodiment of FIG. 1, the public utility is an electrical utility providing electricity. In such case, the utility system 12 is a building electrical system 12, for example a fuse box, circuit breaker box, or junction box connecting the building unit 14 to the utility provider and by which all electricity provided to the building unit 14 is channeled thereto. The utility meter 16 is a conventional electromechanical electricity meter 16, well known in the art. The electricity meter 16 has, as the indicator 18, a disc 18, revolvingly or rotatably mounted therein, and a number of dials 19 as consumption indication devices 19. As is well known in the art for electromechanical electricity meters 16, consumption of electricity causes the disc 18 to revolve, thus indicating consumption, with the disc 18 completing a full revolution or a predefined number of revolutions when a predefined amount of electricity, for example a predetermined number of kilowatt-hours, has been consumed. At the same time, the positions of needles of the dials 19 are modified as the disc 18 revolves to provide readings for the electrical utility provider for billing purposes. Thus, and as is well known in the art, the faster the rate of revolution of the disc 18, the greater the rate of consumption of electricity and the faster and greater the modification of the positions of the needles on the dials 19.

For the exemplary embodiment shown in FIG. 1, the disc 18 has at least one marker 70, for example aperture 70, disposed thereon, preferably proximal to the perimeter of the disc 18 thereof. For example, the disc may have first and second apertures 70a, 70b, preferably diametrically opposed and equidistant to one another. Whenever the same marker 70 on the disc 18 passes by a predefined position twice as the disc 18 revolves, an entire revolution of the disc 18, which may be defined as the predefined event, has occurred. Alternatively, the detection of any one of the markers 70a, 70b could be defined as the event, corresponding to a half-revolution of the disc 18.

The sensor 20 is an optical sensor arrangement 20 disposed outside, i.e. external, the meter 16, but proximal thereto, and which is configured for detecting the marker 70 whenever it passes through the predetermined position. For the exemplary embodiment shown, the sensor arrangement 20 includes a light emitter 74 facing a first side 84a of the disc 18 and a light sensor 76 facing a second side 84b of the disc 18, both in axial alignment with an axis 78 defining the predefined position. The light emitter 74 constantly and continuously emits a light signal, e.g. a beam of light, which is detectable by the light sensor 76 only when the light signal passes through the aperture 70 when the aperture 70 is in the predefined position. Otherwise, the light signal is blocked from detection by the light sensor 76 by the disc 18.

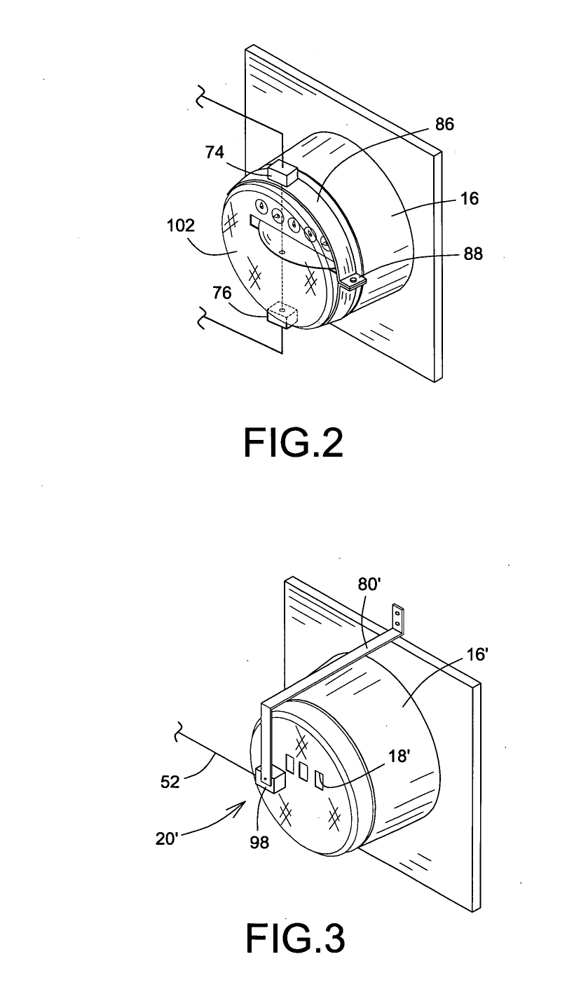

As shown in FIG. 1, the light sensor 76 and light emitter 74 may with respective L-type brackets 80 therefor to a structure 100, such as a wall or plate, in proximity to the meter 16 and in axial alignment with one another and facing opposite sides 84a, 84b of the disc 18. For a variant of the system 10, shown in FIG. 2, the light sensor 76 and light emitter 74 could both be mounted in a single bracket 86 configured for mounting on a meter 16. Typically, the single bracket 86 would be configured for fitting over the perimeter of the meter 16 and possibly tightened using a screw arrangement 88 to secure the bracket 86 with the sensor 76 and light 74 disposed and in axial alignment with one another and facing opposite sides of the disc 18. For example, the bracket 86 could be adapted in size and shape to fit over the meter 16, notably the glass portion 102 thereof, and tightened thereon. The brackets. 80, 86 are exemplary and any means by which the sensor 76 and light emitter 74 may be disposed proximally outside the meter and facing each other in axial alignment in the predefined position may be employed.

The light sensor 76 may be configured to emit an event signal transmitted to the controller 20 over the connection wire 52 or wireless connection 50 every time a predefined number NEI of detections of occurrences of the light signal occurs, NEI being the number of apertures 70. In such case, for which the event would be a full revolution, the controller 20 adds an additional event to the event total, sample or cumulative, every time an event signal is received. As an alternative, the light sensor 76 may send an event signal to the controller 22 every time the light signal is detected thereby, with the controller 22 adding one event to the event total, i.e. the total count of revolutions of the disc 18, for every NEI event signals received. Alternatively, and if desired, the detection of the event indicator 70, i.e. the detection of the aperture 70 may be defined as the event, in which case the event would only constitute partial revolution of the disk where there are two or more apertures 70. For example, where there are two diametrically opposed apertures 70 the partial revolution would be a half revolution of the disc between the first and second apertures 70. The event count would be augmented by 1 every time the aperture 70 is detected. In either case, provided the controller 22 is correctly programmed, for example using the input device 28, with a known consumption amount and a known predefined number of rotations, or portion thereof, corresponding to the consumption amount, the controller 22 and/or the user will be able to calculate the predefined event quantity of electricity consumed per event, whether the event be one or more revolutions or the detection of the aperture 70. The information required for programming the controller 22 with the event and predefined consumption amount therefor, typically expressed in kilowatt-hours, is typically provided by the utility provider and/or the manufacturer of the electricity meter 16.

The first detection of the aperture is, preferably, omitted to ensure that counting of events occurs after the distance between two apertures 70, has been covered before counting begins. Accordingly, it is possible that a slight portion of the electricity consumed may not be counted. Alternatively, the first detection may be counted, although this may lead to a slight overestimation in the complete number of revolutions counted. In either case, a risk of small variation between the amount of electricity actually consumed that reported by the system 10 exists since measurement of consumption of electricity may not necessarily commence with the aperture 70 in the predefined position 72. However, from a cumulative consumption and cost perspective, given the large number of revolutions involved for a billing period, such variations generally of only trivial significance.

For the exemplary embodiment shown in FIG. 3, the utility is also an electrical utility and the meter 16′ is a digital electricity meter 16′. The indicator 18′ is at least one light emitting diode (LED) 18′, and the event is a simultaneous deactivation of all LEDs 18′ at one time which occurs when the predefined event quantity of electricity has been consumed. Otherwise, at least one LED 18′ is activated and emits light detected by the sensor 20′. The sensor 20′ is an optical light sensor 98 disposed outside the meter 16 and proximal thereto, generally facing the LED 18′ and configured for detecting any light emitted by any of the LEDs 18′. The optical sensor 98 may be secured to the meter 16 or a structure by use of a bracket 80′ or any other means by which the sensor 98 may be securely held in a suitable position for detecting any light emitted by any of the LEDs 18′. Whenever the optical sensor 98 does not detect the light one LED 18′, i.e. detects an absence of light from the LEDs 18′, all of the LEDs 20 have been deactivated. Thus, when the optical sensor 98 does not detect any light from LED 18′, the controller 22 may augment the sample or cumulative event total by 1. Once again, the first detection of the event, as with the embodiment shown in FIG. 1, when the system 10 is activated may be omitted to ensure that one complete predefined quantity of electricity (power) has been consumed when counting of the sample or event totals is commenced. The controller 22 may be informed the absence of the light from the LRDs 18′ either by a signal transmitted thereto by the sensor 98 when the absence occurs. Alternatively, the sensor 98 may emit a constant signal transmitted to the controller 22 whenever light any of the LEDs 18′ is detected and which is terminated by the sensor 98 whenever the light is no longer detected. Function and use of the system 10 with the digital electricity meter 16′ is, in all other aspects, the same as for the embodiment of FIG. 1.

For the embodiments shown in FIGS. 1, 2, and 3 in use with an electricity meter 16, 16′, the controller 22 could be programmed, using information provided from a utility provider or manufacturer, such as a user manual for the meter 16, with information specifying a number of events, whether detections of the aperture 70, revolutions of the disc 18, or simultaneous deactivations of LEDs 18′ that are equivalent to a given quantity of electricity, typically expressed in kilowatt-hours. Once this information is stored, the controller 22 may calculate the quantity of kilowatt-hours consumed per a single event, i.e. the predefined event quantity consumed per event.

Referring still to the embodiments shown in FIGS. 1, 2, and 3 in use specifically with an with an electricity meter 16, the user also sets the timing device to the current time and date and starts counting of the event totals of the revolutions of the disc, detections of the aperture, or simultaneous deactivation of all the LEDs as the case may be. The controller 22 may also be programmed with one or more billing periods, for example successive periods of 30 days, as a cumulative or sample time period, using information provided by the electricity provider. Additionally, the user may define sample time periods and projected time periods, such as minutes, hours, days, or months for which the user would like to view current or projected consumption of electricity, which starts respective counting of event totals for each period specified. Alternatively, such time periods could be pre-programmed into the controller 22 or storage device 32. For purposes of calculating consumption costs, the user may enter one or more tariffs for a unit of electricity charged by the electric utility provider for a predefined quantity of electricity, for example a tariff per kilowatt-hour. The user may also enter, in association with each tariff, a consumption range of consumption over a predefined tariff period of time. For example, an electrical utility provider could charge a lower first tariff per kilowatt-hour for the first 0 to 10 kilowatt-hours consumed per day, and then a second, higher tariff the next 11-20 kilowatt-hours per day. Once the tariff, ranges, and time periods, which are typically available on an electricity bill provided by the electrical utility provider, are entered, the controller can convert this information, as described above, to event tariffs, event tariff ranges, and tariff range periods for use in calculating consumption costs, as described previously.

Referring still to the embodiment shown in FIGS. 1, 2, and 3 in use with an electricity meter 16, 16′ once the information for the event, the predefined event quantity, the current, projected, and cumulative time periods, and tariffs are entered, the system 10 commences monitoring the consumption of electricity by the building unit and generates the consumption information including the event totals, consumption totals, and consumption costs for the time periods specified, as described previously. Typically, the user will be able to view consumption information requested using the input device 28 and generated by the controller 22 on the display device 26. For example, the controller 22 could be set, using the input device 28, with sample time periods of a minute and hour, and projected periods of a day, week, month, and year and a cumulative time periods of a month, a typical billing period, and year, and to display the number of events and/or consumption of electricity corresponding thereto for each time period with one or more inputs, for example depressions of a first button, on the input device 28. The controller 22 could also be programmed to display the current number of events, as revolutions or detections of the aperture 70 or deactivation of the LEDs 18′ per minute or hour for the minute or hour currently in progress, as well as the corresponding consumption totals in kWh and consumption cost therefore, as well as the current day, month and year based on the event totals and/or consumption totals for the minute and/or hour in progress. As the event totals, in particular for a sample period of less than a few minutes are reset frequently, the user will be able to rapidly view the effects on current and projected consumption and costs of any changes in consumption in the present, for example, activation of a major appliance such as a dishwasher or the like. The consumption total for the billing time period in progress could also be displayed as consumption information, for example for the current month in progress, and reset at the end of the billing time period, thus allowing the user to avoid unpleasant surprises when the actual bill is received from the electrical utility provider. Provided alarm thresholds are also programmed, using the input device 28, the controller 22 will also cause an alarm to be emitted if consumption for a current, ongoing period of time or projected period exceeds the alarm threshold, thus alerting the user that consumption should be reduced.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

We claim:

1. A monitor system for monitoring utility consumption of a public utility by a utility system of a building unit, the utility system connecting the building unit to the public utility, the utility system being connected to a utility meter having an indicator providing a predefined event whenever a respective predefined event quantity therefor is consumed by the building unit, said monitor system comprising:
a sensor disposed external the meter and proximal thereto, the sensor being configured for detecting the event;
a controller situated within the building unit and programmable with the predefined event quantity and connected to the sensor, the controller being configured for calculating at least one event total calculated by counting each event detected by said sensor; and
a display connected to the controller for displaying consumption information generated by the controller based on said event total and the predefined event quantity.

2. The monitor system of claim 1, wherein the public utility is an electrical utility providing electricity, the utility system is a building electrical system, and the utility meter is an electricity meter.

3. The monitor system of claim 2, wherein said electricity meter is an electromechanical electricity meter, said indicator is a disc mounted in said meter and having at least one marker disposed thereon, the disc revolving as the electricity is consumed, and the event is at least a portion of a revolution of the disc corresponding to passage of said at least one marker during each revolution through a predefined position, said sensor being configured to detect said at least one marker whenever said at least one marker passes into said predetermined position, said controller counting each detection of said at least one marker and augmenting said event total for each said detection.

4. The monitoring system of claim 3, wherein said sensor is an optical sensor arrangement disposed proximal the meter for optically sensing said at least one marker.

5. The monitoring system of claim 4, wherein said at least one marker is at least one aperture in the disc and the optical sensor arrangement comprises a light emitter facing a first side of the disc and a light sensor facing a second side of the disc, said light sensor detecting a light signal constantly emitted by the light emitter and passing through each said aperture when each said aperture passes through said predetermined position, said disc otherwise blocking said light signal and preventing said light sensor from detecting said light signal.

6. The monitoring system of claim 5, wherein said at least one aperture is first and second apertures diametrically opposed to one another on the disc, and said at least a portion of the revolution is a half revolution of said disc between said first and second markers.

7. The monitoring system of claim 1, wherein said sensor is connected to said controller by a wire connection.

8. The monitoring system of claim 1, wherein said sensor is connected to said controller by a wireless connection, said wireless connection comprising a wireless signal emitter connected to said sensor and a wireless signal receiver connected to said controller.

9. The monitoring system of claim 2, wherein the electricity meter is a digital electricity meter, the indicator is at least one light emitting diode, and the event is a simultaneous deactivation of each light emitting diode, at least one said light emitting diode being otherwise activated and emitting light, said sensor comprising an optical sensor disposed proximal and generally facing said at least one light emitting diode and configured for detecting said event when said light from every said light emitting diode is absent.

10. The monitor system of claim 1, further comprising a timer programmable with time information including a time of day, a date, and a year, said timer updating said time information as time progresses.

11. The monitor system of claim 1, further comprising a storage device connected to said controller, said controller storing said consumption information on said storage device.

12. The monitor system of claim 10, wherein said controller is programmable with at least one respective event tariff representing a respective cost for each predefined event quantity, and thereby each event.

13. The monitor system of claim 12, wherein said consumption information comprises at least one programmable predefined sample time period measured by said timer and a sample period event total corresponding to a total of said event counted during said sample time period.

14. The monitor system of claim 13, wherein said consumption information further comprises an approximate sample period consumption total corresponding to said sample period event total for said sample time period.

15. The monitor system of claim 13, wherein said consumption information further comprises a future projected period of time and a projected period consumption total, said projected period consumption total corresponding to a projected consumed amount of the utility for a projected period event total of said event for said projected period of time, said projected period event total for said projected period being proportional to said sample period event total for said sample time period.

16. The monitor system of claim 14, wherein said consumption information comprises a sample period consumption cost for said sample period event total, said sample period consumption cost being calculated based on said at least one respective event tariff and said sample period event total.

17. The monitor system of claim 16, wherein said consumption information comprises a projected period consumption cost for said projected period of time, said projected period consumption cost being based on said at least one respective event tariff and said projected period event total.

18. The monitor system of claim 16, wherein said controller is further programmable, for each event tariff, with a respective event range for a respective tariff period of time, said controller selecting said event tariff for calculating a portion of said sample consumption cost and projected consumption cost for each said event of said sample event total and said projected period total which is within said respective event range for said respective tariff period of time.

19. The monitor system of claim 16, wherein said at least one sample time period and said projected time period is one of a minute, an hour, a day, a month, and a billing period defined by a utility provider which provides the utility.

20. The monitor system of claim 1, further comprising a user input device connected to said controller and to said display, said user input device permitting selection of said consumption information and programming of said controller with the predefined event quantity, the event, at least one event tariff for the event, and a sample projected time periods for which said consumption information will be generated.
